(19) United States
(12) Patent Application Publication
(10) Pub. No.: US 2011/0178894 A1
(43) Pub. Date: Jul. 21, 2011

(54) System and Method for the Distribution and Consolidation of Apparel

(76) Inventor: Ryan Steelberg, Irvine, CA (US)

(21) Appl. No.: 13/008,311

(22) Filed: Jan. 18, 2011

Related U.S. Application Data
(60) Provisional application No. 61/336,248, filed on Jan. 19, 2010.

(51) Int. Cl. G06Q 30/00

(52) U.S. Cl. 705/26.7; 705/27.1

(57) ABSTRACT

A system and method of handling purchased goods, are disclosed. The system of handling purchased goods includes a graphical user interface that provides a user at least one fictitious mailing address and access to at least one vendor and a distribution center correspondent to the fictitious mailing address, where the user orders goods from the at least one vendor, and where the goods are consolidated at the distribution center for provision to, and return by, the user.

### CROSS-REFERENCE TO RELATED APPLICATIONS

This application is a utility application and claims priority to U.S. Provisional Application No. 61/336,248, filed on Jan. 19, 2010, which is hereby incorporated by reference for all purposes as if fully set forth herein.

### FIELD OF THE INVENTION

The present invention is directed to a distribution network and, more particularly, to a system and method for tracking and distributing items, such as apparel, and returning unconsumed items to a location of origin.

### BACKGROUND OF THE INVENTION

Purchasing clothes and apparel items can be difficult and time consuming. Although purveyors of such goods provide not only traditional brick-and-mortar stores, but also virtual store websites via the internet, inconveniences abound. For example, a traditional brick-and-mortar store may present a very large and cumbersome allocation of space, which may not be conducive to locating a particular item for purchase. Conversely, traditional stores may also be boutiques that offer limited selection, that are individually spread over a wide geographic area, and that thus are not easily accessible from any one location. Adding to the difficulties associated with traditional stores may be the distraction of children, spouses, and/or friends who may not be fully committed to the shopper's goal.

Although some, if not all, of these issues may be eliminated with shopping via the internet, inconveniences may not be completely eliminated. For example, a shopper may purchase goods that have to be returned for some reason, leaving the task of repackaging and shipping items to the buyer after those items have been removed from the original packaging. Thus, the buyer must package the items, and often travel to a shipping point. This risk of return is heightened via Internet shopping, in part because the consumer can't view, or try on, the items before purchase. For this reason, consumers sometimes avoid Internet shopping, in spite of the heightened convenience.

Consequently, the inconveniences associated with shopping for clothes and apparel at both traditional and virtual outlets may cause shoppers to purchase less, or to focus on fewer outlets to limit the exposure to these inconveniences. Thus, consumers may buy less, and retailers may suffer.

Thus, there exists a need for a system and method that allows for the limiting of inconveniences associated with shopping at both traditional and virtual stores, such as by eliminating the need for the shopper to visit and navigate multiple traditional stores, and/or to handle returns for Internet purchases.

### SUMMARY OF THE INVENTION

The present invention provides a method and system for the purchase and centralized review of goods. In an aspect of the present invention, the goods may be garments and accessories selected from one or more remote stores through a user interface. Each selected good may be shipped to a user-assigned, fictitious address that directs at least one group of ordered goods to a centralized location, from which at least one user ordered item may be directed to the user or to a user-identified location.

Thus, the present invention provides a system and method for the purchase and centralized review and/or return of goods.

### BRIEF DESCRIPTION OF THE FIGURES

The present invention will be described herein below in conjunction with the following figures, in which like numerals represent like items, and wherein:

FIG. 1 is a flow chart illustrating an aspect of the present invention;

FIG. 2 is an illustration of a process of an aspect of the present invention;

FIG. 3 is an illustration of a process of an aspect of the present invention;

FIG. 4 is an illustration of a process of an aspect of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical sales engines, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention provides a method and system for the purchase and centralized review and/or return of merchandise. In an aspect of the present invention, the merchandise may be items such as garments and accessories. For example, a user may select one or more garments from at least one remote store through a user interface. Each selected garment may be shipped to the user's assigned shipping address, which may direct the at least one group of ordered garments to a centralized location, and/or the user may direct the item to the nearest, or most convenient, local central reception point. From this centralized location, at least one user ordered item may be directed to the user or to an otherwise user identified location.

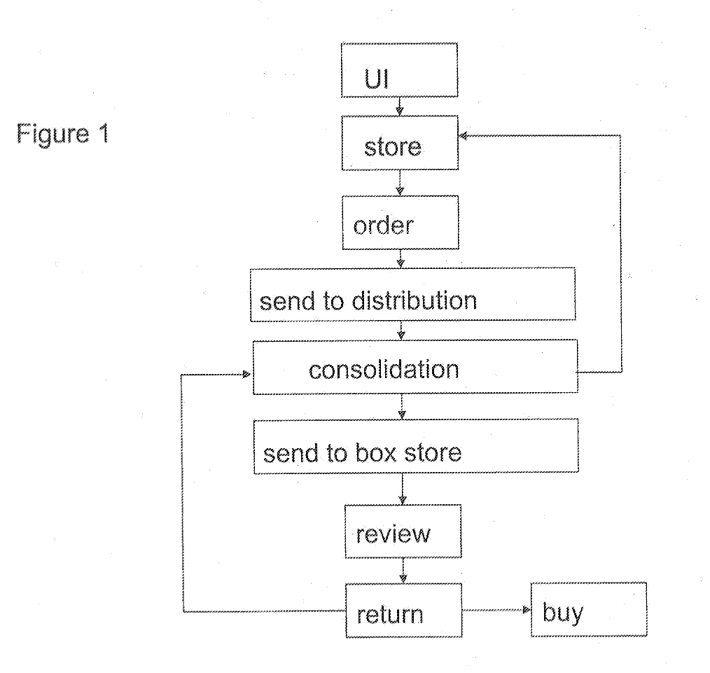

As illustrated in FIG. 1, the present invention may provide the user with at least one user interface. The user interface may, directly or indirectly, provide access to at least one virtual store front from which the user may purchase merchandise. If merchandise is purchased by the user, a predetermined mailing address may be used to ship the merchandise to a centralized distribution center. The predetermined mailing address may be selected by the user, such as for convenience, or may be selected by the interface or by the provider of the interface as nearest to, or most useful to, the user. Thereby, merchandise may be optionally consolidated for shipment to the central distribution center. Once the merchandise arrives at the centralized distribution center, other purchases from the user may be consolidated for shipment to the specified location. Once in the possession of user, the merchandise is reviewed and may be returned if unsatisfactory, such as to the specified location.

Additionally and alternatively, returns, consolidated or otherwise, may be shipped back to the centralized distribution center and packaged and returned to the origination point. The user is subsequently credited with any credits owed them, given the return as if the centralized distribution center was not involved.

In a manner similar to the receiving of shipments, returns may be sent to the centralized distribution center in at least a partially consolidated manner by the user. The goods may then be shipped by the centralized distribution center back to the store from which the goods were originally sent. The consolidation of goods back to the origin of purchase creates many efficiencies and cost savings. For example, multiple goods from different users may be shipped in bulk back to the same originating merchant. Similarly, bulk shipping allows for less packaging and resources to be used and may allow for lesser man-power based on fewer packages to be assembled and tracked. Additionally, the use of materials may be further reduced by recycling materials received from any one of the merchants and/or user(s), such as wherein the merchandise is removed from the packaging for acceptance by the user, at the specified delivery location. This may be especially acute in relation to the packaging received from merchants, since many shipments destined for one user may be consolidated—potentially leaving a high amount of residual packaging materials.

In an embodiment of the present invention, a user may establish an alias, That is, a pseudo-shipping address and other user characteristics. For example, a user may register with a web portal designed to provide the user with one or more of a unique user identification, a fictitious mailing and billing address (distinct from the user's home or work address), a password and/or an encryption key, for example. The web portal may be a third party website which may allow users to click through to particular vendor sites while maintaining the identity and user identifiers associated with the registered user. As one skilled in the art will appreciate, such a user registration may be established within the provided web portal, or directly through a participating vendor. Similarly, a user who is assigned a unique mailing address, for example, may simply use the fictitious address as the shipping address of choice.

Consolidation may occur at a particular location remote from the user and before receipt of the goods by the user. In an embodiment of the present invention, the consolidation of goods may occur at a distribution hub. This distribution hub may, for example, be the receiving location of a user's fictitious address. Consolidation may include the repackaging of multiple shipments into fewer shipments. Such consolidation may also include the assembling of multiple shipments or individual shipments of goods into fewer goods.

For example, a user may have several items of clothing sent to the distribution center via his fictitious address from at least one clothier. This may include a pair of pants, a blouse, and a blazer. These goods may be consolidated at the centralized distribution center and may be organized on a hanger or mannequin, for example, to be presented as an outfit in one shipment. Thus, the goods may be arranged to show a real-life presentation of the goods and may allow the user to better evaluate the goods individually and in relation to each other.

In an embodiment of the present invention, the user purchased merchandise may originate from many distinct store fronts and/or vendors. The goods may be shipped to the at least one central distribution location. Once the goods suitably arrive at the central distribution center, goods from multiple shipments may be associated with a single user and may be consolidated into a single shipment. In furtherance of the example discussed above, the at least one single shipment may be arranged in at least one real-life presentation, and may be sent to the user or a location designated by the user.

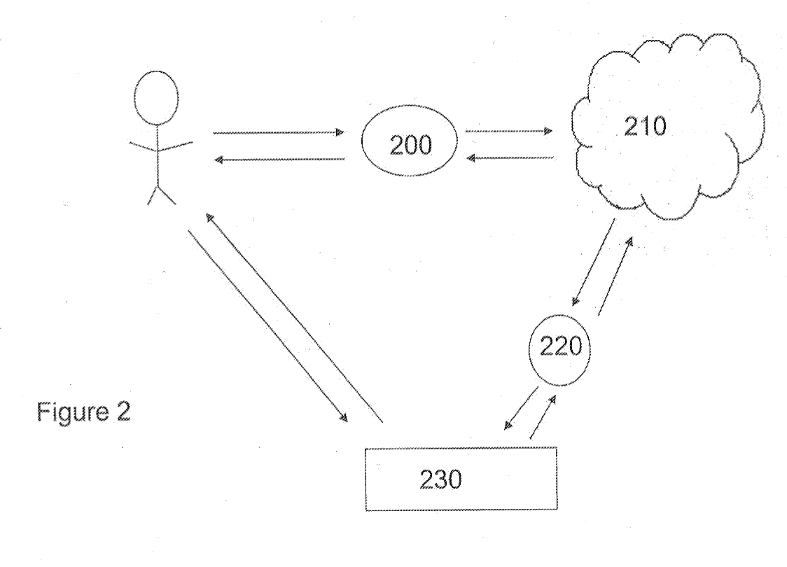

As illustrated in FIG. 2, a user may engage a user interface 200 which may be associated with at least one vendor 220 via connection 210. The interface 200 may be provided by the vendor 220 or a third party and may include, for example, a simple web browser or more robust interface, as may be appreciated by those skilled in the art. The user may place at least one order with the vendor 220, and may use at least one fictitious address as the shipping address of the purchased goods. The goods may then be shipped and received at a centralized distribution hub 230. The at least one received shipment may be consolidated as discussed above and may then be delivered to the user, either at the user's address or at a local point, such as at a local retailer for distribution. As used throughout herein, the shipping and/or delivery of goods may be accomplished using any known method, including the use of common carrier, proprietary vehicles and/or personnel, for example.

After receipt, the user may choose to return all or a portion of the goods to the vendor 220. The user may ship or deliver the goods to be returned to the centralized distribution hub 230. Shipment from the centralized distribution hub 230 back to the vendor 230 may occur at anytime after the goods are received, and may include goods from more than one user. In an embodiment of the present invention, goods originating from the same vendor 220 and received from at least two users may be consolidated for shipping back to the common vendor 220. Such a consolidation of shipping and packaging of goods, including the related discussions above, may increase efficiencies and provide costs savings in both manpower and materials used.

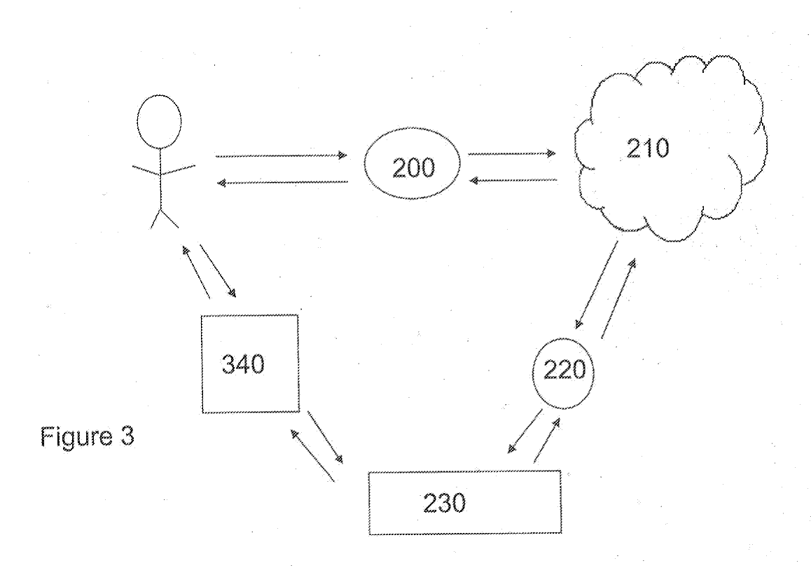

In an embodiment of the present invention, and as illustrated in FIG. 3, the goods may also be shipped to a box store 340. The user may elect this option for several reasons, including convenience of pick-up and return, for example. By way of non-limiting example, the goods may be displayed for viewing and/or handling by the box store 340 and may provide the user with an easy route for rejecting and returning goods by allowing the box store 340 to handle the return of the goods. Similarly, and as discussed above, the goods may also be displayed in a real-life presentation and may be presented to the user by appointment, for example.

For example, a user may have goods from at least one vendor 220 shipped to box store 340, such as via the centralized distribution hub 230, and may wait for a notification from the box store 340 that the shipment(s) were received and are ready for viewing and/or handling. After notification and arrival at the box store 340, the user may take home any one of the goods and may leave any remaining items for return to the vendor 220. The box store 340 may consolidate and return goods, in a similar manner to that discussed above, and may return the goods to the centralized distribution center 230.

In an embodiment of the present invention, the box store 34 may additionally add items to those originally ordered by the user, as in the above example, and provide the user with an enhanced presentation of the goods and/or an additional purchasing opportunity. For example, the user may order only a pair of shoes and a pair of jeans. To enhance the display of items, the box store 340 may include additional items, such as a shirt, watch, and hat, for example. These additional items may originate at the box store 340 and/or may be provided by a vendor 220.

In an embodiment of the present invention, a recommendation engine may be provided to facilitate the choosing of the items, or of the items for the enhancement of good(s) presentations. As understood by those skilled in the art, the recommendation engine may provide a selection of complimentary goods to the user's selection(s) and may automatically ship the box store 340 goods from at least one vendor 220 and/or provide a list of goods resident at the box store 340 that may be suitable. The shipment of suggested goods may also take place absent the involvement of the box store 340 and may allow for the shipment to the user of as-yet-purchased goods for review and/or handling. In this way, the user/vendor/distribution chain may act to provide the user with goods and suggested goods, within the confines of an established and convenient user procurement process.

The recommendation engine may create suggestions by comparing the user's selections to a list of items in a database assigned similarity codes pertaining to things such as color, style, predetermined accessory/item, and season, for example. The recommendation engine may also track a user's purchases, for example, and may provide suggestions based in part on past purchases.

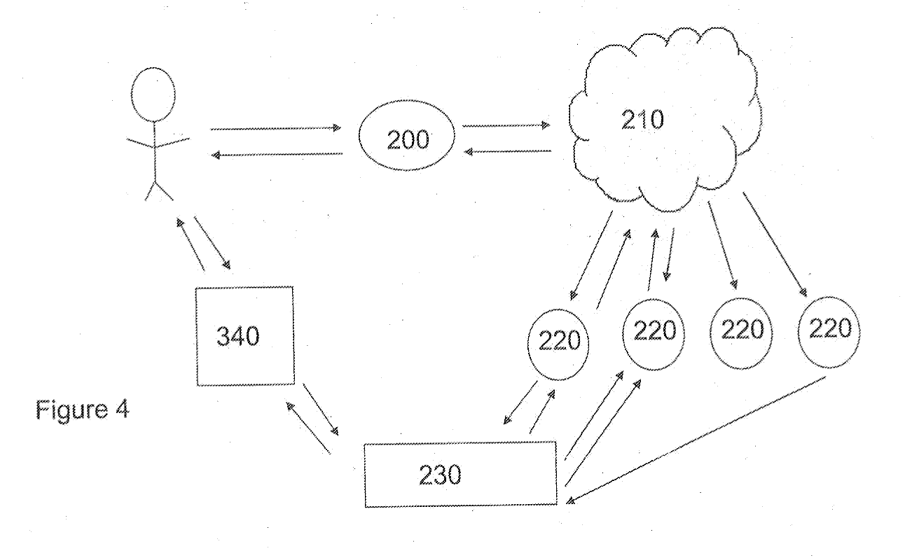

As illustrated in FIG. 4, and as briefly discussed above, a user may order goods from multiple sources and may have such purchases consolidated and presented for review and/or handling. For example, a user may access at least two distinct vendor websites and purchase a variety of goods from each, using at least the user provided fictitious address. The goods from the multiple vendors 220 may then be shipped to a centralized distribution center 230 for consolidation and shipment to the user or to a box store 340, for example.

The purchasing of goods by the user may happen over a period of time, such as a weekend, a holiday, or a season, for example. The consolidation and shipment of goods from the centralized distribution center 340 may preferably occur weekly, daily, or bi-monthly for example. The user may also define the time delay period for shipment, such as, for example, monthly, and/or may simply queue purchases for a user initiated timed ship. Alternatively, the user may simply choose not to control the timing of shipping and/or ultimate delivery and may choose to wait until the goods are fully delivered to begin review and/or handling. As mentioned above, the box store or other receiving location may alert the user of what has arrived and allow the user to choose the time for review and/or handling. As used herein throughout, box store may include large chain shops, such as Nordstrom's, Sears, Macys, The Gap, Wal-Mart and/or Target, and other venues where the user may engage in the reviewing and handling process remote from the user's home or work location.

Further, the user preferably pays for the goods at the time of purchase and before shipment from a vendor. A vendor may allow for differed payments or other mechanisms so as to permit the user to pay for only those goods for which final custody is taken. In this way, for example, a user may order and review/handle goods at a box store and make payment only on those items the user removes from the box store. As one skilled in the art would understand, payment may be made at the time of removal to the box store, or payment may be charged/processed by the vendor based on the removal of the goods and/or based on the absence of a return within a defined period of time.

Although included in many of the above examples, in an embodiment of the present invention, neither the hub nor the box store need be present for the system to operate. For example, a user may have the fictitious address directed to a PO Box or another private location.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A computer-implemented system comprising at least one computerized memory communicatively associated with at least one processor programmed for providing for the handling purchased goods, comprising:
a graphical user interface that provides a user at least one fictitious mailing address and access to at least one vendor; and
a distribution center correspondent to said fictitious mailing address;
wherein the user orders goods from the at least one vendor, and wherein the goods are consolidated at least at said distribution center for provision to, and return by, the user.

2. The system of claim 1, further comprising a box store for receiving the consolidated purchased goods from the distribution center and arranging the purchased goods for provision to the user in an arranged fashion.

3. The system of claim 2, further comprising a recommendation engine, wherein unpurchased goods are suggested for inclusion with the purchased goods based on user attributes.

4. The system of claim 1, wherein the fictitious mailing address is selected from at least two mailing addresses

5. The system of claim 1, wherein payment for the goods is made after receipt of the goods by the user.

6. A method of handling purchased goods, comprising the steps of:
providing a computer-implemented system comprising at least one computerized memory communicatively associated with at least one processor programmed for providing access to a graphical user interface;
providing a user at least one fictitious mailing address and access to at least one vendor through said graphical user interface; and
providing access to a distribution center correspondent to said fictitious mailing address;
wherein the user orders goods from the at least one vendor, and wherein the goods are consolidated at least at said distribution center for provision to, and return by, the user.

7. The method of claim 1, further comprising the step of providing access to a box store for receiving the consolidated purchased goods from the distribution center and arranging the purchased goods for provision to the user in an arranged fashion.

8. The method of claim 7, further comprising the step of providing a recommendation engine, wherein unpurchased goods are suggested for inclusion with the purchased goods based on user attributes.

9. The method of claim 6, wherein the fictitious mailing address is selected from at least two mailing addresses

10. The method of claim 6, wherein payment for the goods is made after receipt of the goods by the user.

11. A computer-implemented system comprising at least one computerized memory communicatively associated with at least one processor programmed for providing for the handling purchased goods, comprising:
a graphical user interface that provides a user at least one fictitious mailing address and access to at least one vendor; and
a means for distribution correspondent to said fictitious mailing address;
wherein the user orders goods from the at least one vendor, and wherein the goods are consolidated at least by said means for distribution for provision to, and return by, the user.
